(19) United States
(12) Patent Application Publication
(10) Pub. No.: US 2018/0132032 A1
(43) Pub. Date: May 10, 2018

(54) Earpiece with Modified Ambient Environment Over-ride Function

(71) Applicant: BRAGI GmbH, Munchen (DE)

(72) Inventors: Peter Vincent Boesen, München (DE); Darko Dragicevic, München (DE)

(73) Assignee: BRAGI GmbH, München (DE)

(21) Appl. No.: 15/804,086

(22) Filed: Nov. 6, 2017

Related U.S. Application Data
(60) Provisional application No. 62/417,379, filed on Nov. 4, 2016.

(51) Int. Cl. H04R 1/10; H04R 3/00

(52) U.S. Cl. CPC H04R 1/1083; H04R 3/00; H04R 2430/01; G10K 2210/1081; H04R 1/1091

(57) ABSTRACT

An earpiece includes an earpiece housing sized and shaped to block an external auditory canal of a user, at least one microphone positioned to sense ambient sound, a speaker, and a processor disposed within the earpiece housing and operatively connected to each of the at least one microphone and the speaker, wherein the processor is configured to modify the ambient sound based on user preferences to produce modified ambient sound in a first mode of operation and to produce a second sound in response to a trigger condition. The second sound may be an unmodified version of the ambient sound. The second sound may be a modified version of the ambient sound which suppresses at least a portion of the ambient sound. The second sound may be a warning sound.

### PRIORITY STATEMENT

This application claims priority to U.S. Provisional Patent Application No. 62/417,379 filed on Nov. 4, 2016 titled Earpiece with Modified Ambient Environment Over-ride Function, all of which is hereby incorporated by reference in its entirety.

### FIELD OF THE INVENTION

The present invention relates to wearable devices. More particularly, but not exclusively, the present invention relates to earpieces.

### BACKGROUND

Earpieces may block all sounds from the ambient environment. In certain circumstances, however, a wearer of an earpiece may wish to hear certain sounds from the ambient environment while filtering out all other ambient sounds. Thus there is a need for a system and method of providing a user with the option of permitting one or more sounds from the user's ambient environment to be communicated without allowing other ambient sounds to reach the user's ears.

### SUMMARY

Therefore, it is a primary object, feature, or advantage of the present invention to improve over the state of the art.

It is a further object, feature, or advantage of the present invention to provide one or more filtered ambient sounds in response to a user preference.

It is a still further object, feature, or advantage of the present invention to provide such filtered ambient sounds in real time.

It is another object, feature, or advantage of the present invention to provide an over-ride function to modify the ambient sound according to one or more trigger conditions.

One or more of these and/or other objects, features, or advantages of the present invention will become apparent from the specification and claims follow. No single embodiment need provide each and every object, feature, or advantage. Different embodiments may have different objects, features, or advantages. Therefore, the present invention is not to be limited to or by an objects, features, or advantages stated herein.

According to one aspect, an earpiece includes an earpiece housing sized and shaped to block an external auditory canal of a user, at least one microphone positioned to sense ambient sound, a speaker, and a processor disposed within the earpiece housing and operatively connected to each of the at least one microphone and the speaker, wherein the processor is configured to modify the ambient sound based on user preferences to produce modified ambient sound in a first mode of operation and to produce a second sound in response to a trigger condition. The second sound may be an unmodified version of the ambient sound. The second sound may be a modified version of the ambient sound which suppresses at least a portion of the ambient sound. The second sound may be a warning sound. The earpiece may further include a gestural interface operatively connected to the processor. The earpiece may further include an inertial sensor operatively connected to the processor.

According to another aspect, a method of improving audio transparency of an earpiece is provided. The method may include receiving ambient sound at a microphone of the earpiece, processing the ambient sound using a processor of the earpiece according to a user setting to produce a modified ambient sound. The method may include further processing the modified ambient sound to include a warning sound in response to a trigger condition, and producing the modified ambient sound at a speaker of the earpiece. The method may further include processing the modified ambient sound to suppress at least a portion of the ambient sound.

### BRIEF DESCRIPTION OF THE DRAWINGS

FIG. 1 includes a block diagram of one embodiment of the system.

FIG. 2 illustrates a system that includes a left earpiece and a right earpiece.

FIG. 3 illustrates a right earpiece and its relationship to an ear.

FIG. 4 includes a block diagram of a second embodiment of the system.

FIG. 5 includes a flowchart of one implementation of the method.

### DETAILED DESCRIPTION

An earpiece or a set of earpieces may include an audio transparency mode of operation where the earpieces physically block the external auditory canal of a user and environmental or ambient sound is detected using one or more microphones of the earpiece and reproduced at a one or more speakers of the earpiece. Instead of reproducing the ambient sound exactly, the ambient sound may be processed by one or more processors of the earpiece to create a modified ambient sound according to one or more user preferences. An over-ride function may be performed to over-ride this functionality in one of several ways. The over-ride function may be used to cease outputting the modified ambient sound. The over-ride function may be used to further process the modified ambient sound to introduce a warning sound into the modified ambient sound. The over-ride function may be used to cease outputting the modified ambient sound and reproduce the ambient sound in an unmodified form. The over-ride function may be invoked in response to a trigger condition. The trigger condition may be any number of conditions which may be determined by a user or a manufacturer. These trigger conditions may be based on the ambient sound. For example, if the ambient sound is at a volume which exceeds a pre-set threshold, the trigger condition may be met. These trigger conditions may be based on other sensor information such as biometric or physiological information sensed with one or more biometric sensors of the earpiece or motion data sensed with an inertial sensor of the earpiece. For example, if movement of the user exceeds a certain speed, the trigger condition may be met.

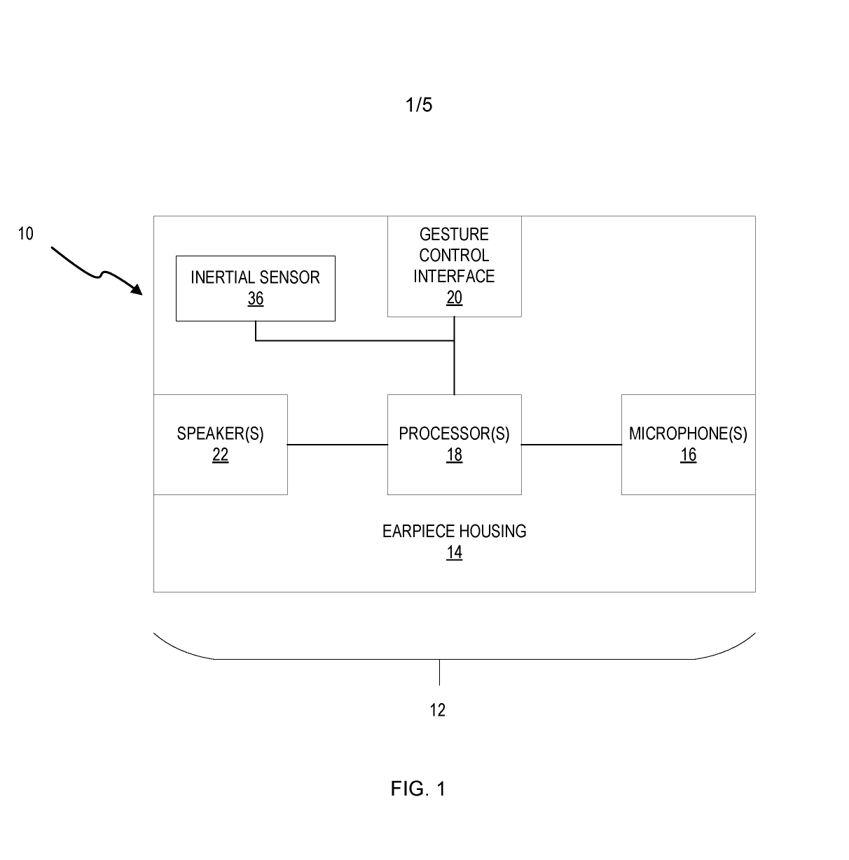

FIG. 1 illustrates a block diagram of the system 10 having at least one earpiece 12 having an earpiece housing 14. A microphone 16 is positioned to receive ambient sound. One or more processors 18 may be disposed within the earpiece housing 14 and operatively connected to microphone 16. A gesture control interface 20 is operatively connected to the processor 18. The gesture control interface 20 configured to allow a user to control the processing of the ambient sounds. An inertial sensor 36 is also shown which is operatively connected to the one or more processors. One or more speakers 22 may be positioned within the earpiece housing 14 and configured to communicate the ambient sounds desired by the user. The earpiece housing 14 may be composed of soundproof materials to improve audio transparency or any material resistant to shear and strain and may also have a sheath attached in order to improve comfort, sound transmission or reduce the likelihood of skin or ear allergies. In addition, the earpiece housing 14 may also substantially encompass the external auditory canal of the user in order to substantially reduce or eliminate external sounds to further improve audio transparency. The housing 14 of each wearable earpiece 12 may be composed of any material or combination of materials, such as metals, metal alloys, plastics, or other polymers having substantial deformation resistance

One or more microphones 16 may be positioned to receive one or more ambient sounds. The ambient sounds may originate from the user, a third party, a machine, an animal, another earpiece, another electronic device or even nature itself. The types of ambient sounds received by the microphones 16 may include words, combination of words, sounds, combinations of sounds or any combination of the aforementioned. The ambient sounds may be of any frequency and need not necessarily be audible to the user.

The processor 18 is the logic controls for the operation and functionality of the earpiece(s) 12. The processor 18 may include circuitry, chips, and other digital logic. The processor 18 may also include programs, scripts and instructions, which may be implemented to operate the processor 18. The processor 18 may represent hardware, software, firmware or any combination thereof. In one embodiment, the processor 18 may include one or more processors. The processor 18 may also represent an application specific integrated circuit (ASIC), system-on-a-chip (SOC) or field programmable gate array (FPGA).

The processor 18 may also process gestures to determine commands or selections implemented by the earpiece 12. Gestures such as taps, double taps, triple taps, swipes, or holds may be used. The processor 18 may also process movements by the inertial sensor 36. The inertial sensor 36 may be a 9-axis inertial sensor which may include a 3-axis accelerometer, 3-axis gyroscope, and 3-axis magnetometer. The inertial sensor 36 may serve as a user interface. For example, a user may move their head and the inertial sensor may detect the head movements.

In one embodiment, the processor 18 is circuitry or logic enabled to control execution of a set of instructions. The processor 18 may be one or more microprocessors, digital signal processors, application-specific integrated circuits (ASIC), central processing units or other devices suitable for controlling an electronic device including one or more hardware and software elements, executing software, instructions, programs, and applications, converting and processing signals and information and performing other related tasks. The processor may be a single chip or integrated with other computing or communications components.

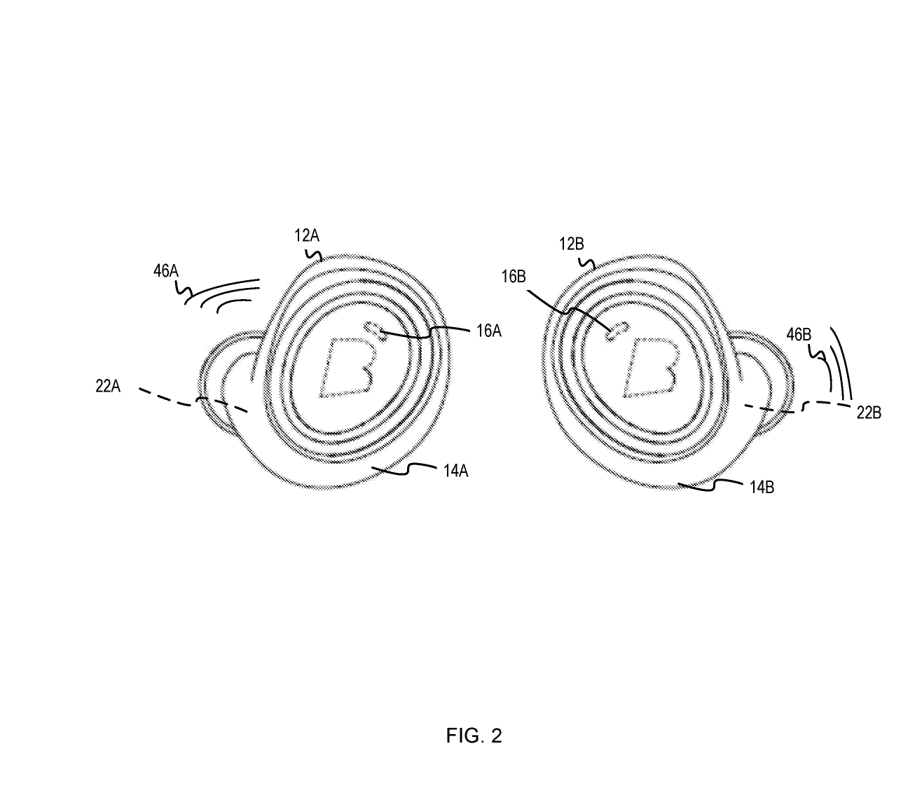

A gesture control interface 20 is mounted onto the earpiece housing 14 and operatively connected to the processor 18 and configured to allow a user to select one or more sound sources using a gesture. The gesture control interface 20 may be located anywhere on the earpiece housing 14 conducive to receiving a gesture and may be configured to receive tapping gestures, swiping gestures, or gestures which do not make contact with either the gesture control interface 20 or another part of the earpiece 12. FIG. 2 illustrates a pair of earpieces which includes a left earpiece 12A and a right earpiece 12B. The left earpiece 12A has a left earpiece housing 14A. The right earpiece 12B has a right earpiece housing 14B. A microphone 16A is shown on the left earpiece 12A and a microphone 16B is shown on the right earpiece 12B. The microphones 16A and 16B may be positioned to receive ambient sounds. Additional microphones may also be present. Speakers 22A and 22B are configured to communicate modified sounds 46A and 46B after processing. The modified sounds 46A and 46B may be communicated to the user

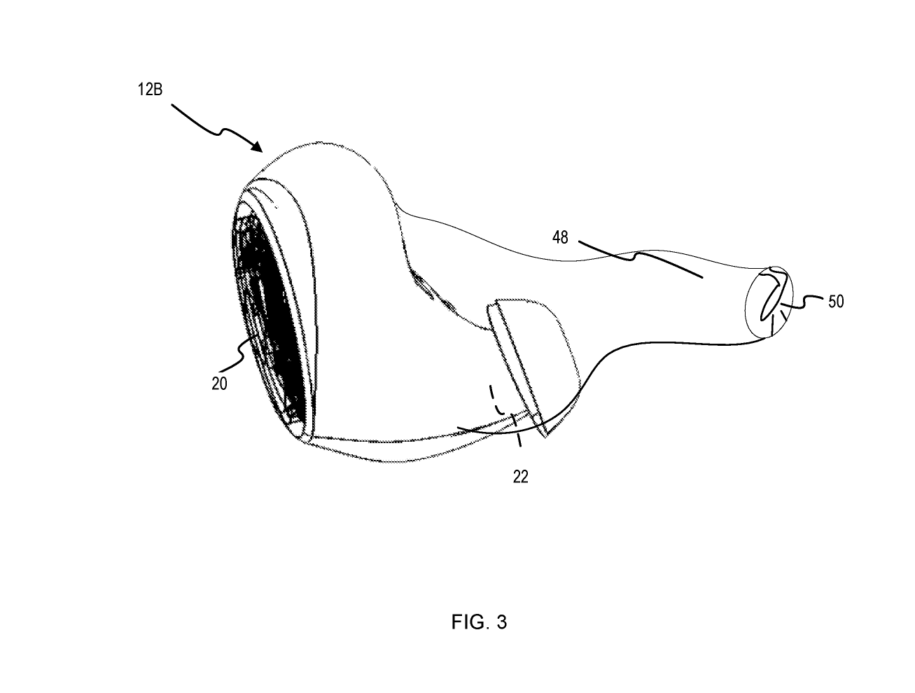

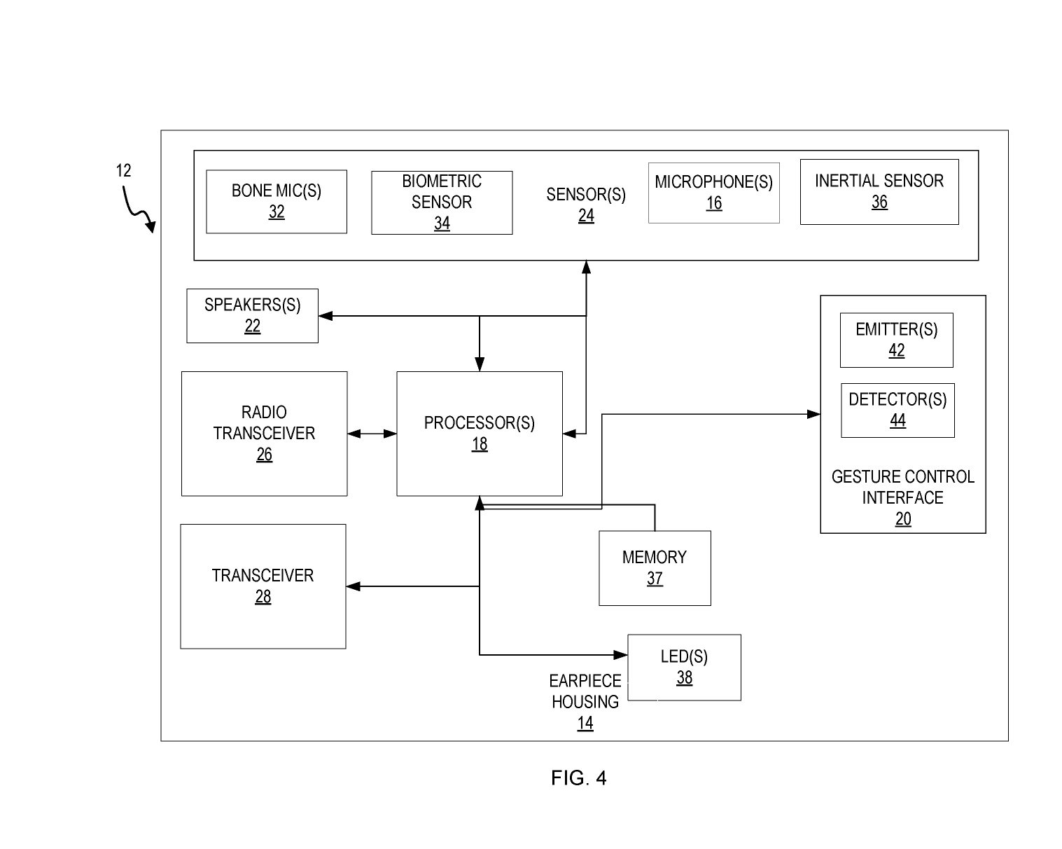

FIG. 3 illustrates a side view of the right earpiece 12B and its relationship to a user's ear. The right earpiece 12B may be configured to isolate the user's ear canal 48 from the environment so that the user does not hear the environment directly, but may hear a reproduction of the environmental sounds as modified by the earpiece 12B which is directed towards the tympanic membrane 50 of the user. There is a gesture control interface 20 shown on the exterior of the earpiece. FIG. 4 is a block diagram of an earpiece 12 having an earpiece housing 14, and a plurality of sensors 24 operatively connected to one or more processors 18. The one or more sensors may include one or more bone microphones 32 which may be used for detecting speech of a user. The sensors 24 may further include one or more biometric sensors 34 which may be used for monitoring physiological conditions of a user. The sensors 24 may include one or more microphones 16 which may be used for detecting sound within the ambient environment of the user. The sensors 24 may include one or more inertial sensors 36 which may be used for determining movement of the user such as head motion of the user which may be used to receive selections or instructions from a user. A gesture control interface 20 is also operatively connected to the one or more processors 18. The gesture control interface 20 may be implemented in various ways including through capacitive touch or through optical sensing. The gesture control interface 20 may include one or more emitters 42 and one or more detectors 44. Thus, for example, in one embodiment, light may be emitted at the one or more emitters 42 and detected at the one or more detectors 44 and interpreted to indicate one or more gestures being performed by a user. One or more speakers 22 are also operatively connected to the processor 18. A radio transceiver 26 may be operatively connected to the one or more processors 18. The radio transceiver may be a BLUETOOTH transceiver, a BLE transceiver, a Wi-Fi transceiver, or other type of radio transceiver. A transceiver 28 may also be present. The transceiver 28 may be a magnetic induction transceiver such as a near field magnetic induction (NFMI) transceiver. Where multiple earpieces are present, the transceiver 28 may be used to communicate between the left and the right earpieces. A memory 37 is operatively connected to the processor and may be used to store instructions regarding sound processing, user settings regarding selections, or other information. One or more LEDs 38 may also be operatively connected to the one or more processors 18 and may be used to provide visual feedback regarding operations of the wireless earpiece.

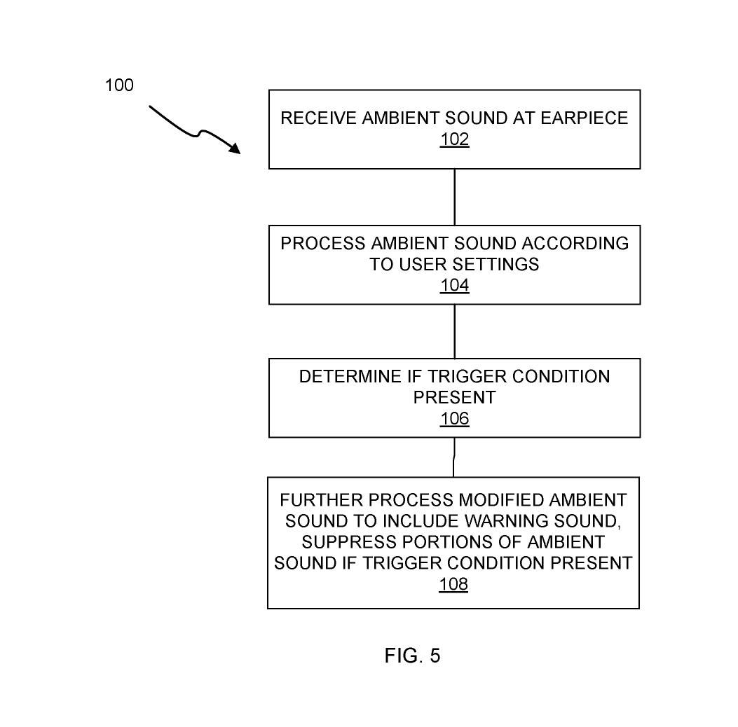

FIG. 5 illustrates one example of a method 100. In step 102 ambient sound is detected or received at one or more microphones of an earpiece. In step 104, the ambient sound is processed according to user settings. The user settings may provide for amplifying the ambient sound, filtering out sound of particular frequencies, filtering out sound of particular types, changing the frequency of the sound, or otherwise modifying the ambient sound. The user may specify the settings in various ways including through voice command, use of the gestural interface, use of the inertial sensor, or through other electronic devices in operative communication with the earpiece. For example, a software application may operate on a mobile device in operative communication with the wireless earpiece which allows the user to specify the settings. The settings may be stored in a non-transitory machine readable storage medium of the earpiece. Next in step 106, a determination is made as to whether the trigger condition is present. The trigger condition may be specified in the same manner as the user settings. The trigger condition may also be provided as a manufacturer setting as well. The trigger condition may be a parameter of the ambient sound, of the modified ambient sound, or a condition associated with user movement data sensed with an inertial sensor, physiological parameters sensed with a biometric sensor or other type of trigger condition. Examples of trigger conditions may include sound which exceeds both a pre-set intensity and a pre-set frequency, sound which exceeds a pre-set intensity, sound which exceeds a pre-set frequency, movement which exceeds a pre-set velocity, movement which exceeds a pre-set acceleration, heart rate which exceeds a pre-set heart rate, or other type of trigger condition. If the trigger condition is present, then step 108 further processing of the modified ambient sound may be performed. The further processing may be to include a warning sound within the modified ambient sound. This may be in the form of a tone, a voice warning, or other sound. The further processing may be to suppress portions of the ambient sound. For example, where the trigger is associated with the sound exceeding a pre-set intensity and/or frequency, the further processing may be to suppress the high-frequency tone or the intensity or both. Next the modified ambient sound as further modified to suppress portions thereof or to include a warning sound may be reproduced at one or more speakers of the earpiece.

Therefore, various methods, systems, and apparatus have been shown and described. Although various embodiments or examples have been set forth herein, it is to be understood that the present invention contemplates numerous options, variations, and alternatives as may be appropriate in a particular application or environment.

1. An earpiece comprising:
an earpiece housing sized and shaped to block an external auditory canal of a user;
at least one microphone positioned to sense ambient sound;
an inertial sensor;
a speaker; and
a processor disposed within the earpiece housing and operatively connected to each of the at least one microphone, the inertial sensor, and the speaker, wherein the processor is configured to modify the ambient sound based on user preferences to produce modified ambient sound in a first mode of operation and to produce a warning sound in response to a trigger condition, the trigger condition based on movement sensed with the inertial sensor that exceeds a threshold.

2. The earpiece of claim 1 wherein the warning sound is an unmodified version of the ambient sound.

3. The earpiece of claim 1 wherein the warning sound is a modified version of the ambient sound which suppresses at least a portion of the ambient sound.

4. (canceled)

5. The earpiece of claim 1 further comprising a gestural interface operatively connected to the processor.

6.-9 (canceled).

10. A method of improving audio transparency of an earpiece comprising:
receiving ambient sound at a microphone of the earpiece;
processing the ambient sound using a processor of the earpiece according to a user setting to produce a modified ambient sound;
further processing the modified ambient sound to include a warning sound in response to a trigger condition, wherein the trigger condition is met when a parameter sensed with an inertial sensor of the earpiece exceeds a threshold; and
producing the modified ambient sound at a speaker of the earpiece.

11. The method of claim 11 further comprising further processing the modified ambient sound to suppress at least a portion of the ambient sound.

12. (canceled)

13. (canceled)

14. An earpiece comprising:
an earpiece housing sized and shaped to block an external auditory canal of a user;
at least one microphone positioned to sense ambient sound;
a biometric sensor;
a speaker; and
a processor disposed within the earpiece housing and operatively connected to each of the at least one microphone, the biometric sensor, and the speaker, wherein the processor is configured to modify the ambient sound based on user preferences to produce modified ambient sound in a first mode of operation and to produce a second sound in response to a trigger condition, the trigger condition based on a biometric parameter sensed with the biometric sensor.

15. A method of improving audio transparency of an earpiece comprising:
receiving ambient sound at a microphone of the earpiece;
processing the ambient sound using a processor of the earpiece according to a user setting to produce a modified ambient sound;
further processing the modified ambient sound to include a warning sound in response to a trigger condition, wherein the trigger condition is met when a physiological parameter sensed with a biometric sensor of the earpiece exceeds a threshold; and
producing the modified ambient sound at a speaker of the earpiece.
